(19) United States
(12) Patent Application Publication
(10) Pub. No.: US 2009/0274868 A1
(43) Pub. Date: Nov. 5, 2009

(54) PROTECTIVE COVER SYSTEM FOR AN AREA RUG

(76) Inventors: Chris Hellman, Fenton, MO (US); Stacey Hellman, Fenton, MO (US)

Correspondence Address: POLSINELLI SHUGHART PC, 700 W. 47TH STREET, SUITE 1000, KANSAS CITY, MO, 64112-1802, US

(21) Appl. No.: 12/113,797

(22) Filed: May 1, 2008

(51) Int. Cl. B32B 3/04

(52) U.S. Cl. 428/123; 156/91

(57) ABSTRACT

A protective cover system for an area rug is disclosed. The protective cover system includes a protective cover forming a peripheral lip adapted to engage the bottom peripheral portion of the area rug. The peripheral lip may include a plurality of tightening straps adapted to engage the protective cover to the area rug in order to securely tighten it by adjusting the straps. The peripheral lip may also include a plurality of rubber pads that provide traction with the underlying floor to prevent the area rug from slipping or bundling up.

### FIELD

This document relates to a protective cover system for an area rug, and in particular to a protective cover that fits over an area rug.

### BACKGROUND

Area rugs are commonly used in areas of a home to provide an aesthetic appeal as well as prevent certain floor areas of the home from becoming too worn due to foot traffic, such as hallways, entryways and living room areas. As such, area rugs can become dirty, worn out and frayed over time, thereby necessitating either periodic cleaning or complete replacement of the area rug. In addition, area rugs may be placed in areas where children may play which can be undesirable since the expensive area rugs can become dirty or prematurely worn out in a children's play area.

In addition, area rugs can slip when placed on a relatively smooth floor surface, such as a wood floor, and walked on which can also cause the area rug to become bundled up or moved from its original placement on the floor. Although, rubber floor mats have been developed that may be placed between the area rug and the floor, such floor mats can also become compressed, thereby causing the area rug to become bundled up. As such, the area rug is continuously required to be straightened out and/or moved back to its original placement position on the floor.

Accordingly, there is a need in the art for a protective cover system for an area rug that covers and protects the rug from dirt, spills and premature wear. There is a further need in the art for a protective cover for an area rug that prevents the area rug from slipping relative to the floor as well as becoming bundled up when walked upon.

### SUMMARY

In an embodiment, a protective cover system may include a protective cover adapted to engage and cover an area rug in a manner that protects the top portion of the area rug. The protective cover may include a flexible sheet body defining a top portion and a bottom portion with a peripheral lip defined around the flexible sheet body. The peripheral lip may include a sewn closed pocket along its length that has an elastic liner disposed therein which provides a flexibility and elasticity to the peripheral lip to engage a peripheral bottom portion of the area rug in a manner that permits the protective cover to securely cover the entire top portion of the area rug.

In one embodiment, the protective cover may further include one or more tightening straps attached to the peripheral lip with each tightening step including a distal end having a VELCRO™ attachment adapted to engage the distal end of another tightening strap for tightening and securing the protective cover to the area rug.

In another embodiment, the protective cover may include a peripheral lip that has a plurality of rubber pads or a continuous rubber pad to provide a non-slip surface between the protective cover and the floor that the area rug lies over.

In a further embodiment, a method of manufacturing a protective cover may include providing a flexible sheet body having a top portion and a bottom portion defining a peripheral edge in communication with a peripheral lip. The peripheral edge may be folded inward and a stitch sewn parallel to the peripheral edge such that a closed pocket is defined along the peripheral lip. An elastic liner may be disposed within the closed pocket once the stitch is made in order to provide elasticity to the peripheral lip to facilitate engagement with an area rug.

In an embodiment, another method of manufacturing a protective cover may include providing a flexible top sheet body defining a first peripheral edge and a flexible bottom sheet body defining a second peripheral edge. The flexible top sheet body is aligned with the flexible bottom sheet body such that the first and second peripheral edges are aligned together. A first stitch is then sewn along the aligned first and second peripheral edges to form a flexible sheet body having a top portion and a bottom portion that collectively define a peripheral lip. The stitched first and second peripheral edges are folded inward against the bottom portion of the flexible sheet body and a second stitch is sewn parallel to the first stitch such that a closed pocket is defined along the peripheral lip. An elastic liner may be disposed within the closed pocket to provide elasticity to the peripheral lip to facilitate engagement with an area rug.

In yet other embodiments, the protective cover may have any configuration to comport with the general shape of the area rug to be protected. For example, the protective cover may have a square or rectangular configuration, while in another embodiment the protective cover may have an oval or generally circular configuration. Other embodiments contemplate the protective cover may have a half round, runner or octagon-shaped configurations.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a top view of the protective cover showing a peripheral lip and a closed pocket in phantom;

FIG. 1A is a cross-sectional view of the protective cover taken along line 1A-1A of FIG. 1 showing the peripheral lip of the protective cover;

FIG. 1B is an enlarged view taken from FIG. 1A showing an elastic band disposed inside the closed pocket defined along the peripheral lip of the protective cover;

FIG. 2 is an opposing bottom view of the protective cover showing the peripheral lip and closed pocket;

FIG. 3 is a top view of an area rug adapted for engagement with the protective cover;

FIG. 4 is a bottom view of the protective cover engaged to the area rug;

FIG. 5 is a cross-sectional view taken along line 5-5 of FIG. 4 showing the engagement of the peripheral lip to the area rug;

FIG. 6A-6E illustrate the sequence for manufacturing another embodiment of the protective cover having a first sheet body and a second sheet body sewn together;

FIG. 7A is a bottom view of one embodiment of the protective cover engaged to an area rug showing the tightening straps;

FIG. 7B is a bottom view of another embodiment of the protective cover engaged to an area rug showing rubber pads spaced along the peripheral lip;

FIG. 7C is a bottom view of yet another embodiment of the protective cover engaged to an area rug showing both the rubber pads and tightening straps;

FIG. 8 is a bottom view of another embodiment of the protective cover having a half-circle configuration engaged to an area rug of the same configuration;

FIG. 9 is a bottom view one embodiment of the protective cover having an octagonal configuration engaged to an area rug of the same configuration; and

FIG. 10 is a bottom view of an embodiment of the protective cover having a circular-shaped configuration engaged to an area rug of the same configuration.

Corresponding reference characters indicate corresponding elements among the view of the drawings. The headings used in the figures should not be interpreted to limit the scope of the claims.

### DETAILED DESCRIPTION

Referring to the drawings, an embodiment of the protective cover system is illustrated and generally indicated as 8 in FIG. 4. As shown, the protective cover system 8 provides a means for securing an area rug 12 with a protective cover 10 to cover the area rug 12. The protective cover 10 may be made from a flexible fabric or cloth material that permits the cover 10 to be engaged along the bottom peripheral portion of the area rug 12 such that the top portion 28 of the area rug 12 is completely covered by the protective cover 10.

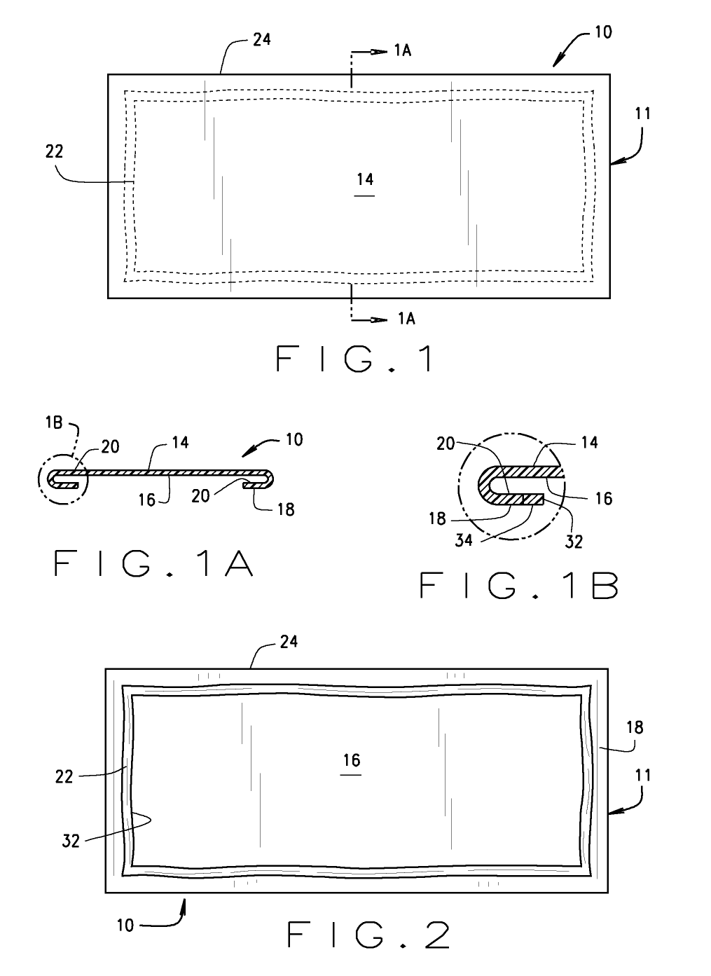

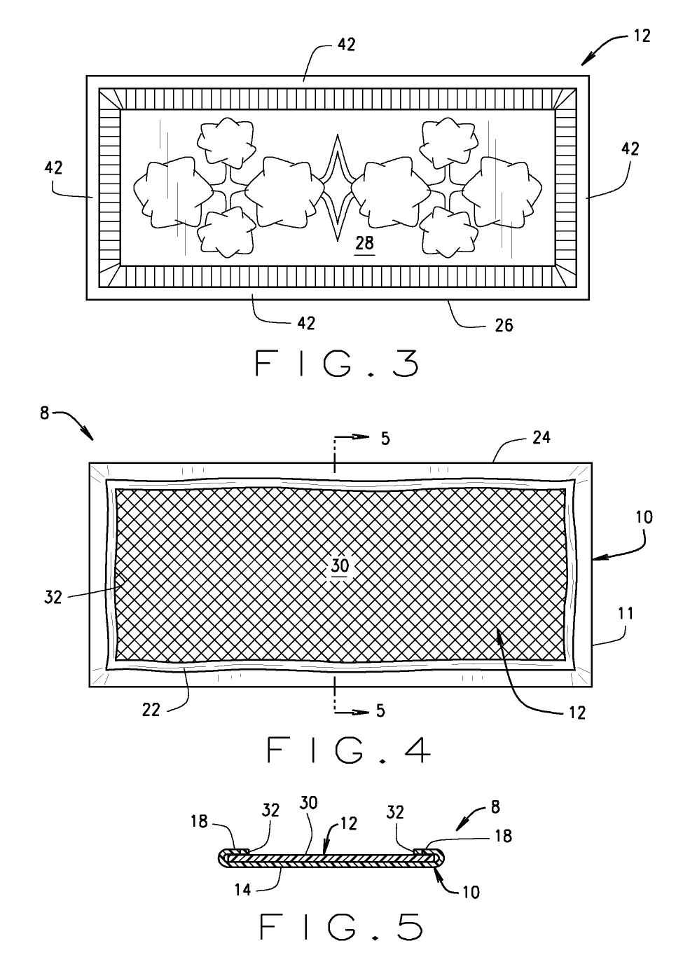

In one embodiment shown in FIGS. 1 and 2, the protective cover 10 may have a generally rectangular configuration for engaging an area rug 12 having a similar rectangular configuration, such as a runner-type area rug 12. The protective cover 10 includes a flexible body 11 having a top portion 14 and an opposite back portion 16 with the flexible sheet body 11 defining a peripheral lip 18 along the entire peripheral area of the area rug 12. The peripheral lip 18 defines a peripheral edge 24 along one side and an inner edge 32 at an opposite side in communication with an open pocket 20. Referring to FIGS. 1-4, the open pocket 20 is adapted to engage a peripheral bottom portion 42 (FIG. 3) of the area rug 12 such that the protective cover 10 completely covers the top portion 28 of the area rug 12 and the peripheral portion 42 of the area rug 12.

Referring to FIGS. 1, 2,4 and 5, the peripheral lip 18 includes a closed pocket 22 along the length of the peripheral lip 18 adjacent the inner edge 32. In one embodiment, the closed pocket 22 may be sewn and an elastic band 32 (FIG. 1B) disposed inside the closed pocket 22 to provide an elasticity to the peripheral lip 18 that allows the peripheral lip 18 of the protective cover 10 to easily fit over the peripheral edge 26 and contact the bottom portion 30 of area rug 12.

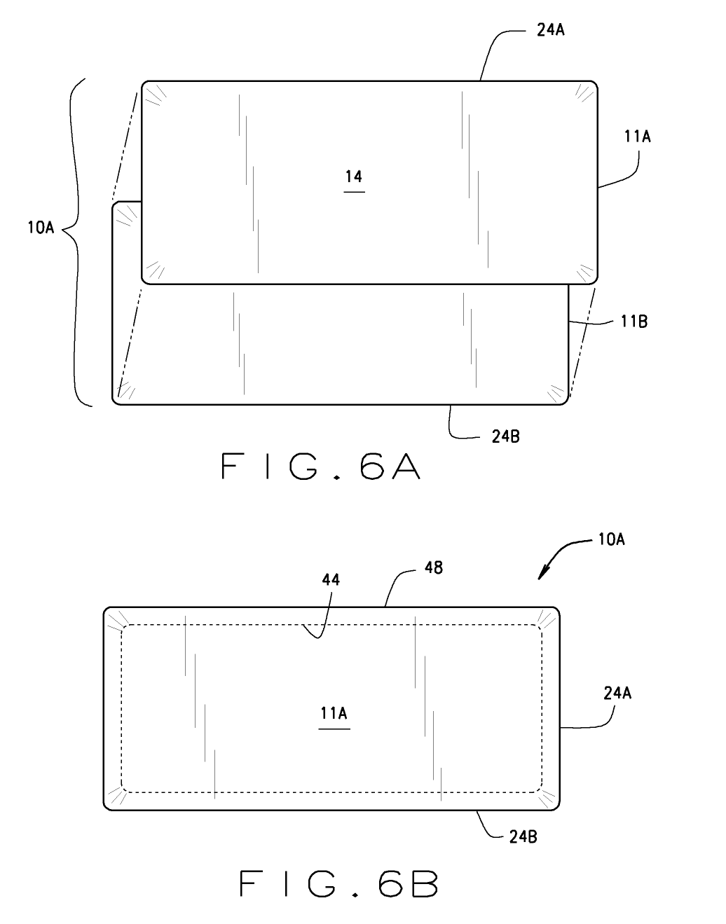

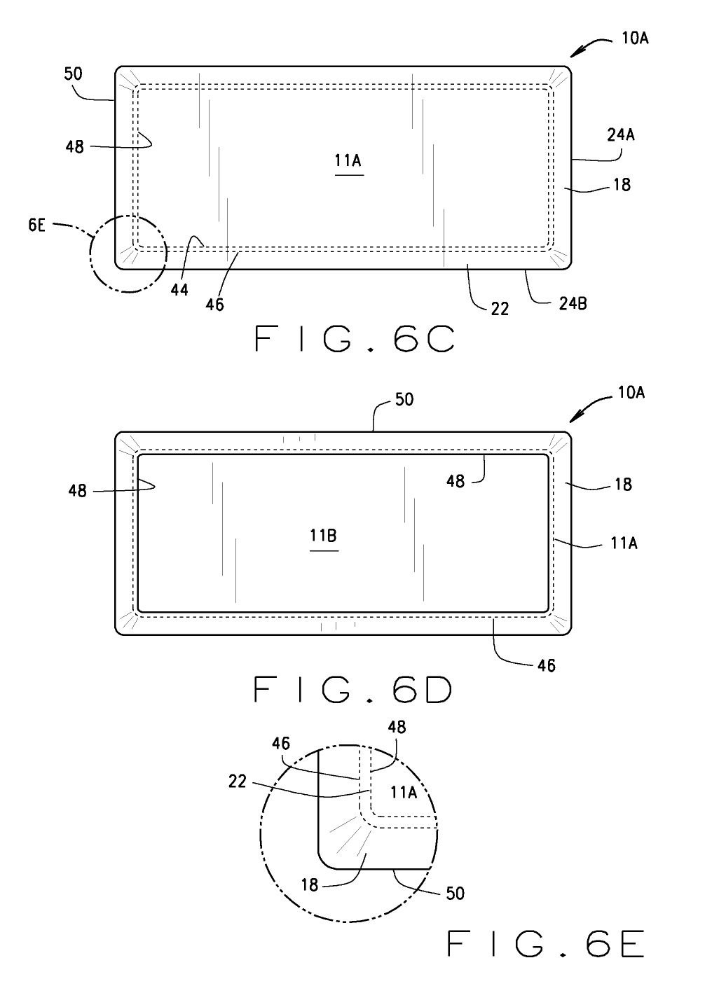

In embodiment of the protective cover system 8 for an area rug 12, protective cover 10A may have a two-part construction having a top sheet body 11A defining a peripheral edge 24A and a bottom sheet body 11B defining a similar peripheral edge 24B that may be sewn together to form a single flexible sheet body 11. As shown in FIGS. 6A and 6B, the peripheral edges 24A and 24B are aligned and a first seam 44 is stitched along edges 24A and 24B. In addition, further seams (not shown) may be sewn between the top sheet 11A and bottom sheet 11B to ensure that the two bodies 11A and 11B are in sufficient contact with one another. Alternatively, an adhesive or other means of bonding may be used to secure the top sheet body 11A to the bottom sheet body 11B. Referring to FIGS. 6C, 6D and 6E, once the peripheral edges 24A and 24B are sewn together along first seam 44 to form an edge 48 peripheral lip 18 is folded inward against the bottom sheet body 11B and a second seam line 46 sewn parallel edge 48 to define a closed pocket 22. As shown, the peripheral lip 18 is defined between a peripheral edge 50 and edge 48. The closed pocket 22 is adapted to receive an elastic liner 34 (FIG. 1B) therein to provide elasticity along the length of the peripheral lip 18.

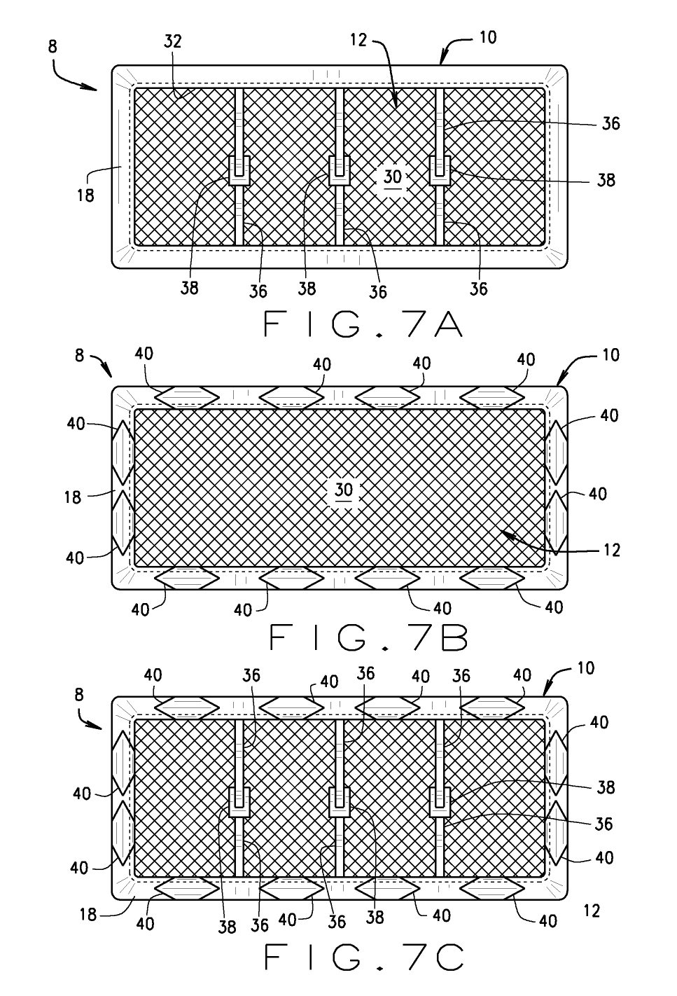

Referring to FIG. 7A, another embodiment of the protective cover system 8 is shown that provides a plurality of straps 36 for tightening the protective cover 10 to the area rug 12. In this embodiment, the plurality of tightening straps 36 may be sewn or otherwise secured to the inner edge 32 of the peripheral lip 18. The distal end of each tightening strap 36 may include a VELCRO™ portion 38 for securing each tightening strap 36 to a respective opposite tightening strap 36 when securing the protective cover 10 to the area rug 12. In other embodiments, portion 38 may have hooks or other elements that permit engagement to the area rug 12.

In another embodiment shown in FIG. 7B, the protective cover 10 may include a plurality of rubber pads 40 spaced around the peripheral lip 18. When the protective cover 10 is engaged to the area rug 12, the peripheral lip 18 is oriented downward such that the plurality of rubber pads 42 contacts the floor under the area rug 12. In this orientation, the plurality of rubber pads 40 provides sufficient traction between the floor and the area rug 12 that prevents the area rug 12 from slipping on the floor or bundling up when walked upon. In another aspect, a continuous rubber pad (not shown) may be attached along the entire length of the peripheral lip 18 rather than a plurality of spaced apart rubber pads 42 to provide traction to the area rug 12.

As shown in FIG. 7C, the protective cover 10 may include a peripheral lip 18 having a combination of the above features. For example, the protective cover 10 may include the plurality of rubber pads 40 spaced along the peripheral edge 18 in combination with the plurality of tightening straps 38 attached to the inner edge 32 of the peripheral lip 18 by respective VELCRO™ portions. This embodiment allows the protective cover 10 to provide additional traction to the area rug 12 while permitting the protective cover 10 to be securely tightened to the area rug 12.

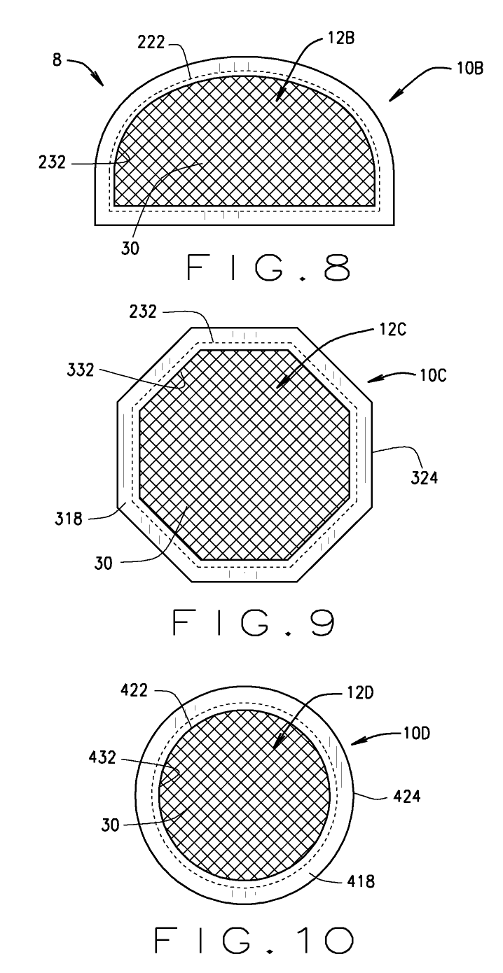

Referring to FIGS. 8-10, other embodiments of the protective cover 10 are disclosed. As shown in FIG. 8, a protective cover, designated 10B, may have a semi-circular configuration adapted to engage an area rug 12B that has a similar shape. In this embodiment, protective cover 10B defines a semi-circular peripheral edge 224 and a similarly shaped inner edge 232 that collectively define a peripheral lip 218. The peripheral lip 218 forms a closed pocket 222 sewn along the peripheral lip 218 that is adapted to receive an elastic liner (not shown) that allows the peripheral lip 218 to stretch and easily fit over the top portion 28 as well as engage the back portion 30 of the area rug 12B by the protective cover 10B.

As shown in FIG. 9, another embodiment of the protective cover, designated 10C, may have an octagonal-shaped configuration adapted to engage an area rug 12C that has a similar octagon shape. In this particular embodiment, protective cover 10C may define an octagonal-shaped edge 324 and a similarly shaped inner edge 332 that collectively define a peripheral lip 318. As noted above, the peripheral lip 318 forms a closed pocket 322 sewn along the peripheral lip 318 that is adapted to receive an elastic liner (not shown) that allows the peripheral lip 318 to stretch and easily fit over the top portion 28 and engage the back portion 30 of the area rug 12C by the protective cover 10C in the same fashion as discussed above.

Referring to FIG. 10, yet another embodiment of the protective cover, designated 10D, may have a circular-shaped configuration adapted to engage an area rug 12D that has a similar circular shape. In this embodiment, protective cover 10D may define a circular-shaped edge 424 and a similarly shaped inner edge 432 that collectively define a peripheral lip 418 having an open pocket (not shown) adapted to engage an area rug 12C. Similar to the other embodiments, the peripheral lip 418 defines a closed pocket 422 sewn along its length adapted to receive an elastic liner (not shown) that allows the peripheral lip 418 to stretch and easily fit over the top portion 28 and engage the back portion 30 of the area rug 12D by the protective cover 10D.

In one aspect, the flexible sheet body 11 of the protective cover 10 may be made from cotton, nylon, acrylic, olefin, polyester, linen, fleece, acetate, latex, rayon, spandex, wool, knot, flannel, canvas, taffeta, puplin, microfiber, synthetic blends, and velour. In another aspect, the flexible sheet body 11 may be made from a material or treated with a sealant that makes the flexible sheet body 11 waterproof.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A protective cover system for an area rug comprising:
a flexible sheet body defining a top portion and a bottom portion, the top portion defining a peripheral edge in communication with a peripheral lip; and
an area rug having a top portion and a bottom portion defining a peripheral edge, the area rug adapted to engage the flexible sheet such that the top portion of the area rug is completely covered by the flexible sheet, wherein the peripheral lip is adapted to be engaged around the peripheral edge of the area rug such that an open pocket is collectively defined between the back portion of the flexible sheet and the peripheral lip to receive the peripheral edge of the area rug.

2. The protective cover system of claim 1, wherein the peripheral lip defines a closed pocket having an elastic band disposed therein for providing elasticity to the peripheral lip.

3. The protective cover system of claim 1, wherein the peripheral lip includes a plurality of tightening straps attached thereto for engagement with another one of the plurality of tightening straps such that the flexible sheet may be secured to the area rug.

4. The protective cover system of claim 3, wherein each of the plurality of tightening straps includes a distal end having a means for engaging another respective one of the plurality of tightening straps.

5. The protective cover system of claim 3, wherein the peripheral lip includes a plurality of rubber pads adapted to provide a gripping surface for the area rug.

6. The protective cover system of claim 1, wherein the peripheral lip includes a plurality of rubber pads adapted to provide a gripping surface for the area rug.

7. The protective cover system of claim 1, wherein the area rug has a circular, semi-circular, oval, rectangular, octagonal, or square configuration.

8. The protective cover system of claim 1, wherein the flexible sheet has a circular, semi-circular, oval, rectangular, octagonal or square configuration.

9. A protective cover system for an area rug comprising:
a protective cover having a flexible top sheet body defining a first peripheral edge and a flexible bottom sheet body having a second peripheral edge with the flexible top sheet body being aligned with the flexible bottom sheet body such that the first and second peripheral edges are sewn together and define a peripheral lip, the peripheral lip defines a closed pocket with an elastic liner disposed within the closed pocket to provide a flexibility and elasticity to the peripheral lip; and
an area rug defining a top portion and a bottom portion including a peripheral bottom portion adapted to engage the peripheral lip of the protective cover such that the top portion of the area rug is covered by the protective cover.

10. The protective cover system of claim 9, wherein the peripheral edge includes a plurality of tightening straps with another one of the plurality of tightening straps for securing the flexible sheet to the area rug.

11. The protective cover system of claim 10, wherein each of the plurality of tightening straps includes a distal end having a means for engaging another respective one of the plurality of tightening straps.

12. The protective cover system of claim 9, wherein the peripheral lip includes a plurality of rubber pads adapted to provide a gripping surface for the area rug to prevent slippage or bundling of the area rug along a floor in which the area rug lies upon.

13. The protective cover system of claim 10, wherein the peripheral lip includes a plurality of rubber pads adapted to provide a gripping surface for the area rug to prevent slippage or bundling of the area rug along a floor in which the area rug lies upon.

14. The protective cover system of claim 9, wherein the area rug has a circular, semi-circular, oval, rectangular, octagonal, or square configuration.

15. The protective cover system of claim 9, wherein the flexible sheet has a circular, semi-circular, oval, rectangular, octagonal or square configuration.

16. A method of manufacturing a protective cover comprising:
providing a flexible sheet body having a top portion and a bottom portion defining a peripheral edge in communication with a peripheral lip;
folding the peripheral edge inward toward the bottom portion of the flexible sheet body;
sewing a stitch parallel to the peripheral edge such that a closed pocket is defined along the peripheral lip; and
inserting an elastic liner within the closed pocket.

17. The method of claim 16, wherein a plurality of tightening straps are attached to the peripheral lip with each of the plurality of tightening straps having a distal end for engaging another respective distal end of another one of the plurality of tightening straps in order to secure the protective cover to the area rug.

18. The method of claim 16, further including adding a plurality of rubber pads to the peripheral lip of the protective cover.

19. A method of manufacturing a protective cover comprising:
providing a protective cover having a flexible top sheet body defining a first peripheral edge and a flexible bottom sheet body defining a second peripheral edge;
aligning the first and second peripheral edges;
sewing a stitch along the aligned first and second peripheral edges to form a flexible sheet body having a top portion and a bottom portion that collectively define a peripheral lip.
folding the stitched first and second peripheral edges inward toward the bottom portion;
sewing a second stitch parallel to the stitched first and second peripheral edges such that a closed pocket is defined along the peripheral lip; and
inserting an elastic liner within the closed pocket to provide elasticity to the peripheral lip.

20. The method of claim 19, wherein a plurality of tightening straps are attached to the peripheral lip with each of the plurality of tightening straps having a distal end for engaging another respective distal end of another one of the plurality of tightening straps in order to secure the protective cover to the area rug.

21. The method of claim 20, further including adding a plurality of rubber pads to the peripheral lip.
